(19) United States
(12) Patent Application Publication
(10) Pub. No.: US 2005/0080925 A1
(43) Pub. Date: Apr. 14, 2005

(54) Method of establishing communications between processing units

(75) Inventor: Dieter Staiger, Weil im Schoenbuch (DE)

Correspondence Address: Gerald R. Woods;IBM Corporation, T81/503, PO Box 12195, Research Triangle Park, NC, 27709, US

(73) Assignee: International Business Machines Corporation, Armonk, NY (US)

(21) Appl. No.: 10/952,351

(22) Filed: Sep. 28, 2004

(30) Foreign Application Priority Data
Sep. 29, 2003 (EP) 03103603.1

(51) Int. Cl. G06F 15/173

(52) U.S. Cl. 709/239; 709/241; 709/253

(57) ABSTRACT

The invention relates to a method of routing a message in a network in which processing units have virtual addresses based on a spatial coordinate system. When a message including a target address is received at a processing unit, the target address is compared to the address of the receiving unit. If the addresses match, the message is processed by the receiving unit. If the addresses don't match, the first unit identifies nearest neighboring unit to which the message can be forwarded. The process is repeated until the message reaches the target system.

### FIELD OF THE INVENTION

The present invention relates to the field of communication networks and more particularly to methods for establishing communications between processing units in such networks.

### BACKGROUND OF THE INVENTION

The implementation of systems of processing units is constantly growing in many fields of technology, including as examples, automobile technology, industrial manufacturing technology, home entertainment technology and home appliance technology. In such systems, each of a number of processing units typically has to execute a particular predefined function. Such systems are sometimes identified as networked embedded systems.

Complex networked embedded systems can include a large number of processing units that may have to communicate with each other. Since even an automobile, not traditionally thought of as having networked electronic systems, may include 70 or more processing units, an effective and reliable communication platform has to be provided.

A simple network for connecting a plurality of processing units is a so-called bus network. In this network topology, a bus connecting all processing units can be represented as a straight line representing a shared communications medium. The communication between the processing units is governed by a bus controller connected to each processing unit.

Another common network topology is a ring network. Here, the media connecting several processing units can be represented by a closed ring. Access to the ring is controlled by bus controllers at the stations or processing units connected to the ring.

A common disadvantage of bus and ring networks is that they are single point of failure systems. If communications is disrupted between any two processing units in the network, the entire network fails. Furthermore the bandwidth of bus and ring networks is constrained because only one processing unit can use the bus or ring at any given time.

In a star-topology network, a central switch controls the access to the bus. The switch, which is connected to all processing units, handles accesses to external systems as well as the communications among the processing units within the star-topology network. In contrast to bus and ring networks, the central switch can allow several processing units to use the star-topology network concurrently.

If a specific processing unit fails or is disconnected from the central switch, the general functionality of the star-topology network is maintained. Nevertheless, a star-topology network system still has a single point of failure in the central switch. If the central switch fails, the entire star-topology network communication fails.

In some environments, and particularly in an automotive environment, processing units perform extremely specific tasks and are organized into subnetworks for performing higher level tasks made up of the specific tasks. Subnetworks can have different requirements relating to real-time behaviors, data exchange rates, signal transmission and signal processing.

Where communications between two processing units belonging to different subnetworks has to be established, the subnetworks are typically connected via gateway controllers. The overall architecture of this type of system can be characterized as heterogeneous.

Heterogeneous networks are a result of continuous integration of newly-developed different communication technologies into existing electronic embedded systems. A requirement for a gateway controller has two main disadvantages. First, the gateway controller represents a potential bottleneck for the data transfer within the network. Second, the gateway controller represents a single point of failure. If a gateway controller fails, all or a significant portion of the entire heterogeneous network may fail.

Furthermore a heterogeneous network may support only limited message routing. The routing of a message between different types of systems in the heterogeneous network can require significant computational efforts to deal with differences such as transmission rates, data formats, etc. The gateway controllers therefore must ordinarily have significant performance capabilities in order to establish fast and reliable message routing within an heterogeneous network.

Some of the disadvantages of the network topologies described above are overcome in neural networks. Neural networks feature an autonomic learning behavior. For instance, when a individual processing unit fails, its general functionality can be taken over by the remaining processing units. Neural networks therefore do not have single points of failure or create bottlenecks in message routing. The drawbacks of neural networks include high performance requirements for individual processing units as well as a need for a multiplicity of connections between individual processing units, which results in a complicated network architecture. These factors make neural networks costly and thus unlikely to be applicable to cost-constrained embedded processing.

FIG. 1A schematically shows a bus network system. A processing unit 100 is connected to a bus controller 102 which is connected to the bus 104. Communication between different processing units 100 is controlled via the bus controllers 102 with the bus 104 as the communication media or platform. In order to transmit a message via the bus 104, a processing unit 100 has to request a bus grant via the bus controller 102.

FIG. 1B shows a similar network architecture in form of a ring system. The processing units 110 are connected to bus controllers 112 that are connected to the ring 114. The communication between the different processing units is provided by the ring 114 and controlled by the bus controllers 112.

FIG. 1C is a block diagram of a star-topology network. Here the individual processing units 120 are connected to bus controllers 122 that are connected to a central switch 124. Depending on the requests generated by the bus controller 122, the central switch 124 establishes connections between the individual processing units. This topology supports simultaneous communications between several pairs of processing units.

FIG. 1D is a block diagram of a heterogeneous network. The heterogeneous network consists of several subnetworks, some of which may have different topologies. In this example, a bus 104, a ring 144 and a central switch 124 of the star network are connected through two gateway controllers 130 and 140.

If a processing unit 110 belonging to a ring subnetwork 114 wants to transmit a message to a processing unit 100 belonging to a bus subnetwork 104, the gateway controller 130 has to establish the connection between the two subnetworks as well as eventually resolve differences between the communication protocols implemented in the two subnetworks.

In the same way, the gateway controller 140 supports communication between the central switch 124 of the star subnetwork and the bus subnetwork 114. Communication between processing units 120 belonging to the star subnetwork and processing units 100 belonging to the bus subnetwork has to be established by both gateway controllers 130 and 140. Both of the gateway controllers 130 and 140 must have significant performance capabilities.

FIGS. 1A-1C represent conventional network topologies for communication purposes. A common disadvantage of these topologies is the existence of single points of failure that can create communication bottlenecks.

In the heterogenous network shown in FIG. 1D, if the bus 104 or the ring 114 or the central switch 124 fails, the corresponding subnetwork may fail without affecting the rest of the heterogeneous network. However, the needed gateway controllers 130 and 140 still limit throughput between subnetworks and still are single points of failure for the heterogeneous network.

### SUMMARY OF THE INVENTION

The present invention is a new network topology and a new method for message routing in a networked embedded computing system. Each processing unit is assigned a virtual address based on spatial coordinates. The coordinate system may be one-, two-, three- or multi-dimensional. According to the choice of the coordinate system, each processing unit is connected to one or more neighboring processing units. A received message can be routed by a first processing unit that has at least a first and a second port and a first virtual address based on a spatial coordinate system. A message received on the first port will include a target virtual address based on the spatial coordinate system. The receiving process unit compares its own virtual address to the virtual address received in the message. If the two addresses match, the first processing unit retains and processes the message.

### BRIEF DESCRIPTION OF THE DRAWINGS

In the following, embodiments of the invention will be described in greater detail by making reference to the drawings in which:

FIG. 1A is a block diagram of a conventional bus network;

FIG. 1B is a block diagram of a conventional ring network:

FIG. 1C is a block diagram of a conventional star-topology network;

FIG. 1D is a block diagram of a conventional heterogeneous network;

FIG. 2A is a block diagram of a two dimensional embodiment of the invention;

FIG. 2B is a block diagram of a preferred embodiment of the invention in the packet switch mode;

FIG. 2C is a block diagram of a preferred embodiment of the invention in a circuit switch mode;

FIG. 3 is a flow chart of the message routing method of the invention;

FIG. 4 is a block diagram of a message processed by the invention;

FIG. 5 is a diagram of the port structure of a processing unit; and

FIG. 6 is a block diagram of a central processing unit included in a processing unit.

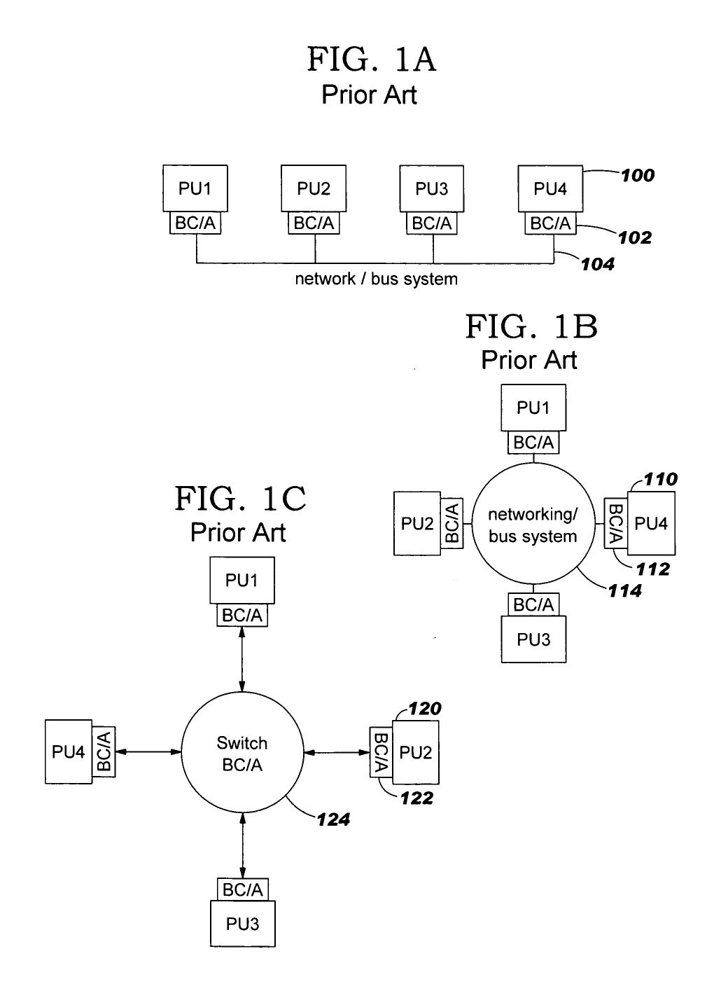

### DETAILED DESCRIPTION

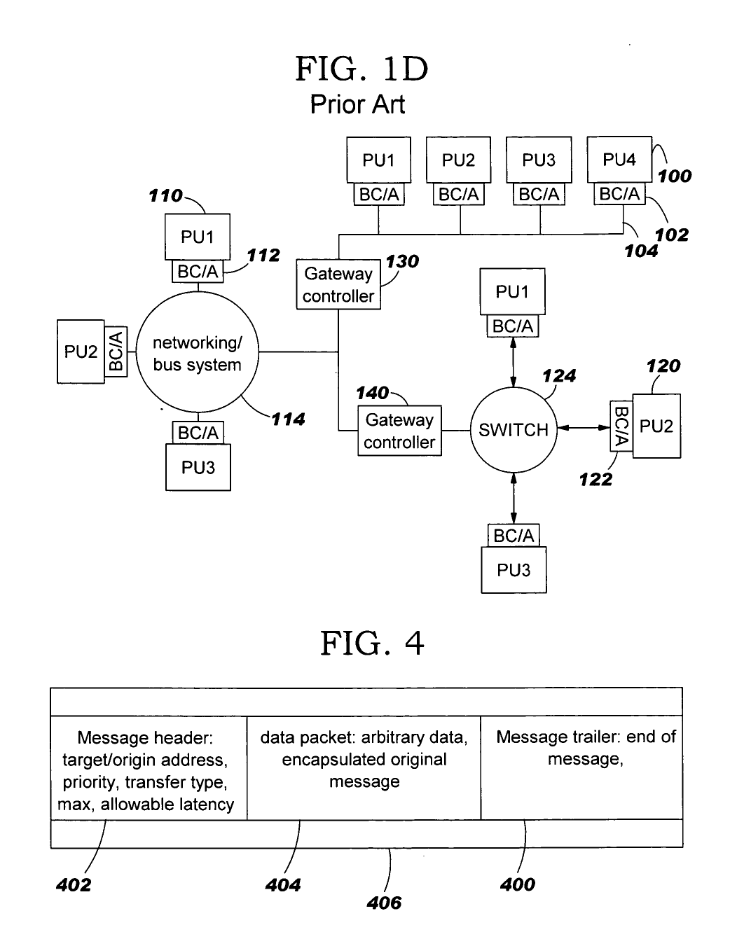

FIG. 2A shows a two dimensional embodiment of the invention. The figure illustrates six processing units 200, 210, 220, 230, 240 and 250, that are arranged in a spatial array. Each of the processing units is ideally connected to four neighboring processing units via horizontal connections 202 and vertical connections 204. Furthermore, each processing unit is assigned a virtual address corresponding to its position in the two dimensional array. Messages to be processed by these processing units include a two dimensional virtual address identifying the target processing unit for the message.

FIG. 2B illustrates the same network as FIG. 2a for the case when the processing unit 230 with the spatial coordinates (0,0) wants to transmit a message to the processing unit 220 with the spatial coordinates (1,2). Depending on the target system's address and the source processing unit's own address and on a computation algorithm, the processing unit 230 identifies one of its nearest neighboring processing units 240 or 200 to which the message initially sent. Before sending the message, the processing unit 230 checks whether the target processing units are capable of receiving the message. If one of the possible target processing units is not capable of receiving the message but other processing units are, the sending processing chooses a destination from the set of processing units that can receive the message.

When the message has arrived at the chosen target processing unit, for example, processing unit 240, the processing unit 240 repeats the processing selecting a new target processing unit from its nearest neighbors, excluding the unit from which the message was received. Depending on the computation algorithm and the availability of the neighboring processing units 210 and 250 the message will be transferred to either the processing unit 250 or to the processing unit 210. The processing unit 250 or 210 will proceed in the same way and transfer the message to the target processing unit 220.

According to the ideal configuration illustrated in FIG. 2B there exist three different paths by which the message can reach the target processing unit via two intermediate processing units. Even in this simple configuration the network provides a variety of alternative paths for a message if a particular processing unit is busy or out of order or becomes disconnected from the source unit.

In a preferred embodiment of the invention the determination of a neighboring processing unit to which a message is to be transferred is such that the distance to the target processing unit is minimized. Suppose that the processing unit 230 wants to transmit the message to the processing unit 240 but the processing unit 240 is not capable of receiving the message, then the processing unit 230 selects the processing unit 200 to send the message to.

If for any reason the processing unit 200 cannot receive the message from the processing unit 230, the processing unit 230 will identify another of its four neighboring processing units to which the message can be transferred. In such a case the message would be initially transferred away from target processing unit 220 rather than toward it. In this way it is guaranteed that the routing of a message does not stop before every effort is made to direct the message toward its target processing unit.

According to a further embodiment of the invention the message that has to be transferred between the processing unit 230 and the processing unit 220 may include a priority identifier indicating that the message is assigned a highest, real-time, priority value. Suppose that in order to transmit the message to its target virtual address the processing unit 230 wants to transmit the message to the processing unit 240, which is currently receiving another message with a lower priority from the processing unit 210. In such a case the transmission of the message with the lower priority would be interrupted in favor of the message with the higher priority. In this way the network provides a near real-time behavior and minimizes the time needed for a routing procedure.

FIG. 2C shows a block diagram of a further embodiment of the invention featuring a circuit switch. According to this ideal embodiment a message path is established connecting a plurality of processing units between the source processing unit and the target processing unit. The routing of the message from the processing unit 230 to the processing unit 220 is realized by:a message path connecting the processing unit 230 with the processing unit 240, connecting the processing unit 240 with the processing unit 250 and connecting the processing unit 250 with the processing unit 220.

The established communication path is indicated by the arrows 260, 262 and 264. In this circuit switch mode the connection 260 between the processing units 230 and 240 is maintained until the processing unit 230 receives a release identifier from the target processing unit 220. The same is true for the processing units 240 and 250.

The drawings represented by FIGS. 2A-2C represent ideal implementations of a two-dimensional network according to the present invention. Other implementations are possible, including for example, an implementation in which at least some processing units are not connected to every possible neighboring processing unit to reduce costs.

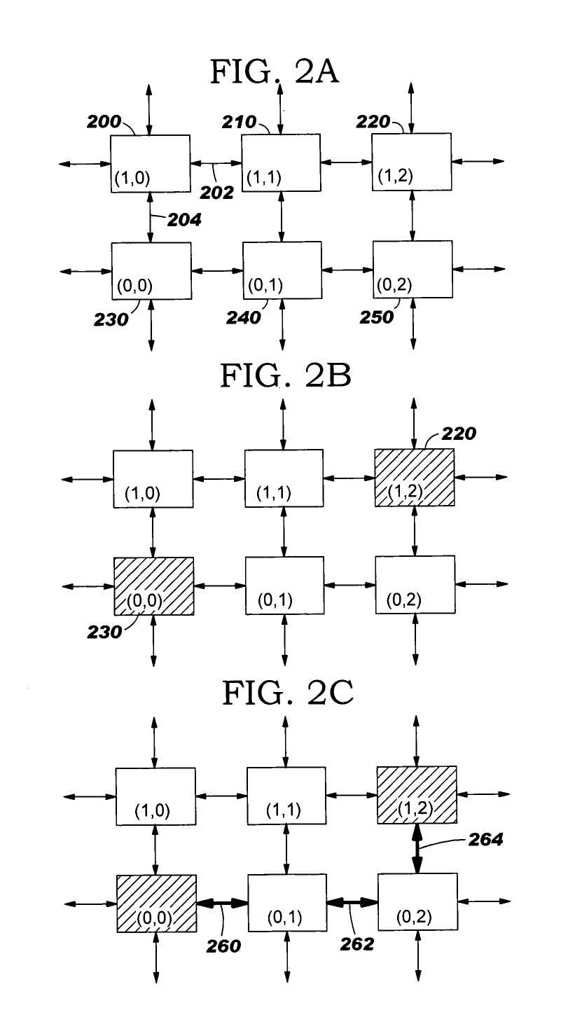

FIG. 3 illustrates a flow chart for the routing algorithm performed by an individual processing unit. In a first step 300 the message is analyzed by the processing unit. In step 300 at least the message origin and the message target and eventually a certain message type is generated from the message header. In step 302 the target virtual address of the message is compared with the virtual address of the processing unit. If in step 302 the virtual address of the message matches the virtual address of the processing unit the message is processed by the processing unit in step 304.

If in step 302 a target virtual address of the message does not match the virtual address of the processing unit the message is further processed in step 306. In step 306 the message priority and the message type is determined. Then the method continues with step 308 in which a message transfer is calculated. According to the calculated message transfer, in the following step 310 a neighboring processing unit is identified. The method then proceeds with step 312. In step 312 the method checks whether the identified neighboring processing unit of step 310 is capable of receiving the message.

If in step 312 the identified neighboring processing unit is capable of receiving the message, the message is then sent to this identified neighboring processing unit in step 314. If in step 312 the neighboring processing unit is not capable of receiving a message then the method returns to step 310 and identifies another neighboring processing unit.

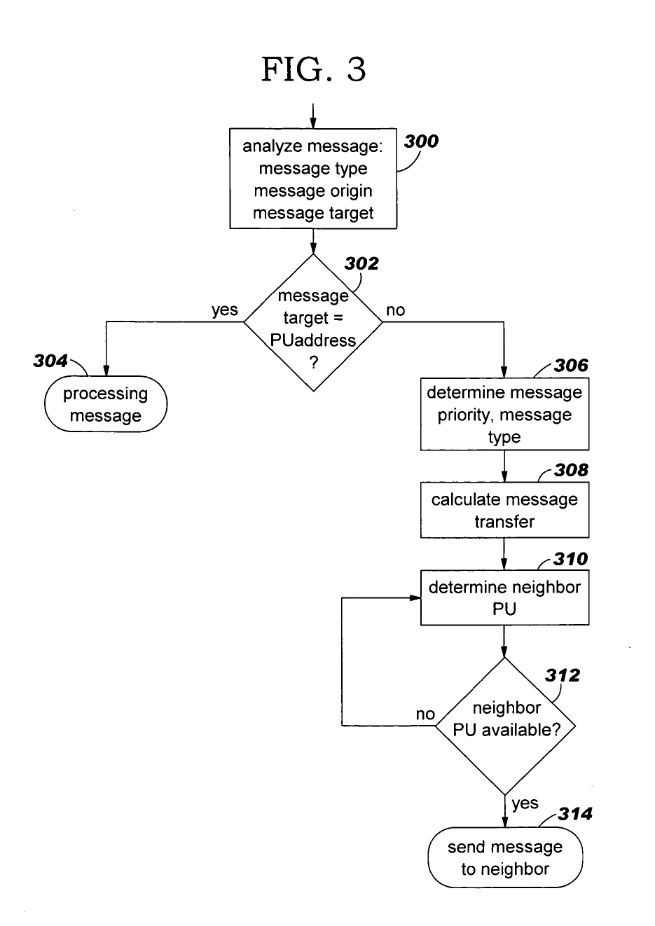

FIG. 4 illustrates a block diagram of a message 400 being transferred and processed by the processing unit of the present invention. The message 400 consists of three different parts: a message header 402, a data packet 404 and a message trailer 406. The message header 402 comprises a target virtual address, a source virtual address, a priority identifier, a transfer type identifier indicating whether the message transfer is synchronous, asynchronous or isochronous and whether the message should be transferred in a packet switched or circuit switched mode. Furthermore the message header defines also a maximum allowable latency time defining a time interval in which a neighboring processing unit has to answer a request of a processing unit in order to be identified as capable of receiving a message.

The data packet 404 comprises an arbitrary data sequence. This arbitrary data sequence may correspond to an encapsulated original message intended for a different kind of subnetwork with a different communication protocol. Finally the message trailer 406 indicates the end of a message.

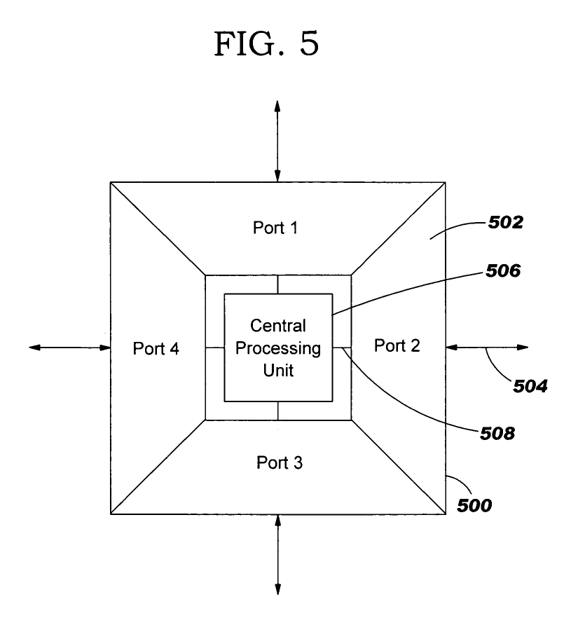

FIG. 5 is a block diagram of a port structure for a processing unit in the two-dimensional embodiment illustrated in FIG. 2a. The processing unit 500 ideally consist of four different ports 502, a central processing unit 506 as well as four connections 508 between the central processing unit 506 and each of the four ports 502. Each port 502 has a connection 504 to a neighboring processing unit. While such a configuration represents an ideal case, other alternative embodiments in which not every connection to every next neighbor is established are possible. In such a case, the processing unit 500 comprises a number of ports 502 that corresponds to the number of next neighbors to which the processing unit 500 is directly connected to.

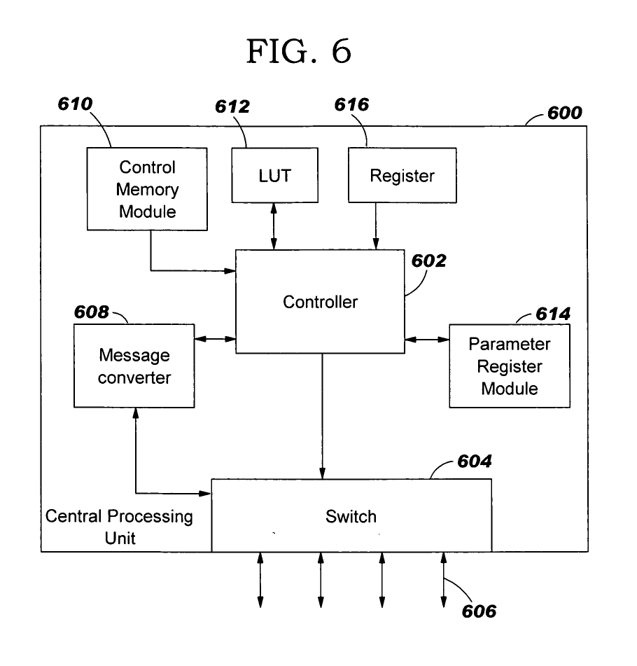

FIG. 6 shows a block diagram of a central processing unit. The central processing unit 600 comprises a controller 602, a switch 604, connections to the ports 606, a message converter 608, a control memory module 610, a look-up table 612 as well as a parameter register module 614 and a register 616. The connections to the ports 606 that connect the central processing unit 600 with the ports of the processing units are connected to the switch 604. The switch 604 is connected to the message converter 608 via a bidirectional connection. The message converter 608 is connected to the controller 602 via a bidirectional connection and the controller 602 is connected to the switch 604 via a unidirectional connection. The controller 602 is further connected to the parameter register module 614. The look-up table 612 is bidirectionally connected to the controller 602 and the control memory module 610 is connected unidirectionally to the controller 602. When a message has been received in the central processing unit 600 by the switch 604, it is directed to the message converter 608. The message converter 608 decodes the virtual address of the message and forwards the decoded information to the controller 602.

The controller 602 performs an arbitration procedure for the routing of the message with the help of a computational algorithm which is stored in the control memory module 610. Depending on the virtual address of the processing unit stored in the register 616 the controller 602 identifies a neighboring processing unit to which the message has to be sent. According to this determination the controller 602 instructs the switch 604 to establish the corresponding connection to the corresponding port. The message is then transferred via the message converter 608 and the switch 604 establishes a connection to the corresponding port and finally to the corresponding neighboring processing unit.

The look-up table 612 is an optional feature when the processing unit is additionally connected to another non-space linked subnetwork. The look-up table 612 for mapping of legacy addresses connected to the controller 602 stores an address translation table for the conversion of the virtual addresses and the potentially involved non-space linked physical addresses of the individual processing units as well as of processing units belonging to a sub-network.

The register 616 in contrast is a significant feature of the central processing unit 600, since it stores the virtual space linked address of the processing unit which is needed for the routing of messages. Preferably the register 616 is designed as a non-volatile memory.

The parameter register module 614 which is connected bidirectionally to the controller 604 stores message state and message type parameters that are necessary for the message routing algorithm performed by the controller 602.

1. A method of routing a message by a first processing unit, the processing unit having at least a first and a second port and having assigned a first virtual address based on a spatial coordinate system, the method comprising the steps of:
(a) receiving a message at the first port, the message including a second target virtual address based on the spatial coordinate system;
(b) comparing the first and the second virtual addresses;
(c) processing the message at the first processing unit if the first address matches the second address;
(d) if the first virtual address does not match the second virtual address, determining a third virtual address corresponding to a second processing unit connected to the first processing unit via one of the at least first or second ports, whereby the third virtual address differs less from the second virtual address than the first virtual address differs from the second virtual address; and
(e) sending the message via one of the at least first or second ports to the second processing unit, corresponding to the third virtual address, if the first virtual address does not match the second virtual address.

2. The method according to claim 1, the message which is transferred from the first processing unit to the second processing unit comprising:
(f) a header comprising a target virtual address;
(g) a data packet comprising an arbitrary data sequence representing a second message with an arbitrary message type related to an arbitrary network system; and
(h) a trailer comprising an identifier determining the end of the message.

3. A method according to claim 2, the first processing unit being available of receiving the first message via the first port when:
(i) no other message is currently transferred via the first processing unit;
(j) the first processing unit is responding to an availability request within a predefined latency time before the message is received by the first processing unit; and
(k) the priority of the first message is higher than the priority of a second message currently being transferred or processed by the first processing unit.

4. The method according to claim 3, sending the message from the first processing unit, further comprising the steps of:
(l) determining whether the second neighboring processing unit is available of receiving the message from the first processing unit before sending the message from the first processing unit to the second processing unit;
(m) sending the message from the first processing unit to the second processing unit, if the second processing unit is available of receiving the message;
(n) determining whether a third neighboring processing unit connected to the first processing unit is available of receiving the message from the first processing unit if the second processing unit is not available, such that the virtual address of the third processing unit differs less from the virtual address of the message than the virtual address of the first processing unit differs from the virtual address of the message;
(o) sending the message (400) from the first processing unit (200) to the third processing unit (230), if the third processing unit (230) is available of receiving the message (400); and
(p) returning to step (n) with another neighboring processing unit connected to the first processing if the third processing unit is not available of receiving the message.

5. The method according to claim 4, further comprising determining a fourth processing unit connected to the first processing unit, such that the virtual address of the fourth processing unit differs more from the virtual address of the message than the virtual address of the first processing unit differs from the virtual address of the message, if neither of those second or third neighboring processing units are available with a corresponding virtual address differing less from the virtual address of the message than the virtual address of the first processing unit differs from the virtual address of the message.

6. The method according to any one of the preceding claims 1 to 5, further comprising that when a first message with a first priority identifier from a first processing unit has to be transferred to a second processing unit currently transferring or processing a second message with a second priority identifier, the transmission or procession of the second message is interrupted and the transfer of the first message to the second processing unit is initiated, if the priority of the second message is lower than the priority of the first message.

7. A processing unit for routing a message, comprising:
(a) at least a first and a second port connecting the processing unit at least to a second and a third neighboring processing unit;
(b) means for sending and receiving messages via the first and the second port;
(c) a first virtual address based on a spatial coordinate system; and
(d) a central processing unit for processing a message and for calculating the routing to a neighboring processing unit.

8. The processing unit according to claim 7, further comprising:
(e) means for comparing a target virtual address of a message with the first virtual address,
(f) means for determining one of the at least second and third processing units, such that the corresponding virtual address of the identified processing unit differs less from the virtual address of the message than the first virtual address differs from the virtual address of the message.

9. The processing unit according to either claim 7 or 8, the central processing unit further comprising a switching module connecting the at least first and second ports with a controller), the controller processing a received message, negotiating with neighboring processing units and checking for availability, determining a single one of the neighboring processing units and sending the message to the identified processing unit via the switching module.

10. The processing unit according to claim 9, the central processing unit further comprising:
(g) a message converter, connecting the switching module and the controller for decoding and/or encoding the target virtual address of a message;
(h) a control memory module connected to the controller, storing an algorithm for an arbitration procedure to be executed by the controller;
(i) a look-up-table connected to the controller, storing an address translation table for the conversion of legacy addresses of subnetworks connected to the processing unit and for the conversion of virtual addresses and physical addresses of at least first, second and third processing units;
(j) a register for non-volatile storage of the virtual address of the processing unit;
(k) a parameter register module connected to the controller, storing message state parameters.

11. A network communication system for transmitting a message from a source processing unit to a target processing unit, the message comprising the virtual address of a source processing unit and the virtual address of a target processing unit, the network communication system comprising:
(a) a first plurality of processing units setting up the network wherein each processing unit is connected to a second plurality of neighboring processing units, such that the second plurality of neighboring processing units is a subset of the first plurality of processing units, each processing unit being assigned to a unique virtual address based on a spatial coordinate system;
(b) means for comparing the target virtual address of a message with a first virtual address of a first one of the first plurality of processing units;
(c) means for determining a second processing unit from the second plurality of processing units, such that the corresponding virtual address of the second processing unit differs less from the virtual address of the message than the first virtual address differs from the virtual address of the message;
(d) means for checking the availability of the second processing unit; and
(e) means for transferring the message from the first processing unit to the second processing unit.

12. The network communication system according to claim 11, the message further comprising:
(f) a header comprising the target virtual address and the source virtual address of the message, an identifier determining the message priority, an identifier determining the message transfer type and an identifier determining a maximum allowable latency time;
(g) a data packet comprising an arbitrary data sequence representing another message with an arbitrary message type related to an arbitrary network system,
(h) a trailer comprising an identifier determining the end of the message.

13. The network communication system according to either claim 11 or 12, further comprising:
(i) means for determining whether the second neighboring processing unit is available to receive the message from the first processing unit before sending the message from the first processing unit to the second processing unit;
(j) means for determining whether a third neighboring processing unit connected to the first processing unit is available to receive the message from the first processing unit, if the second processing unit is not available, such that the virtual address of the third processing unit differs less from the virtual address of the message than the virtual address of the first processing unit differs from the virtual address of the message.

14. A computer program product for a network communication system comprising computer program means for transmitting messages from a source processing unit to a target processing unit by the steps of:
(a) comparing a target virtual address of the message representing the virtual address of the target processing unit with the virtual address of a first processing unit;
(b) processing the message by the first processing unit if the target virtual address of the message matches the virtual address of the first processing unit;
(c) determining a first difference vector comprising the distance between the virtual address of the first processing unit and the target virtual address of the message, if the target virtual address of the message does not match the virtual address of the first processing unit;
(d) determining a second processing unit of neighboring processing units to the first processing unit, to which the message is transferred, such that a second difference vector between the virtual address of the second processing unit and the target virtual address has a smaller norm than the first difference vector,
(e) repeating steps (a) to (d) with the second processing unit as the first processing unit until the virtual address of the first processing unit matches the target virtual address of the message and the message being processed as given by step (b).

15. The computer program product according to claim 14, further comprising computer program means for:
(a) calculating a plurality of difference vectors between the target virtual address of the message and the plurality of virtual addresses of all neighboring processing units connected to the first processing unit;
(b) comparing the difference vectors and determining a third difference vector of the plurality of difference vectors with the smallest norm;
(c) determining a third processing unit belonging to the third difference vector;
(d) determining another difference vector with the second smallest norm from the plurality of difference vectors and its appropriate processing unit, if the third processing unit is not available; and
(e) repeating step (d) with the next smallest difference vector until the appropriate processing unit is available.
